(19) United States
(12) Patent Application Publication
(10) Pub. No.: US 2026/0118153 A1
(43) Pub. Date: Apr. 30, 2026

(54) METHOD FOR ADJUSTING AND/OR CALIBRATING A FLOW METER, AND FLOW METER

(71) Applicant: Endress+Hauser Flowtec AG, Reinach (CH)

(72) Inventors: Michael Blessing, Steinen (DE); Moritz Leopoldo Córdova Murillo, Freiburg (DE); Rebecca Page, Basel (CH); Oliver Hoffmann, Volketswil (CH); Simon Mariager, Basel (CH)

(21) Appl. No.: 19/124,430

(22) PCT Filed: Sep. 15, 2023
(86) PCT No.: PCT/EP2023/075418

§ 371 Date: Apr. 25, 2025

(30) Foreign Application Priority Data
Oct. 26, 2022 (DE) 10 2022 128 366.6

(51) Int. Cl. G01F 25/10

(52) U.S. Cl. CPC G01F 25/10

(57) ABSTRACT

A method for calibrating a flow meter includes a method step of generating an intermittently dynamic flow profile in a line, where the flow profile shows a continuous increase in flow within a first time interval. The method also includes determining the flow profile using a reference flow meter during the first time interval, where a time value is assigned to a measured flow value and the time value is determined by means of a reference clock. The method also includes determining the flow profile using the flow meter during the first time interval, where a time value is also assigned to a measured flow value and the time value is determined by means of a flow meter clock. The method also includes adapting the flow profile determined using the flow meter, to the flow profile determined using the reference flow meter within the first time interval.

The invention relates to a method for adjusting and/or calibrating a flow meter and to a flow meter for determining a flow of a flowable medium.

Especially in the adjustment and calibration technology of liquid and gas flow meters, the test objects (the flow meter to be adjusted/calibrated) are compared with references. The comparison is made by having a medium (liquid or gas) first flow through a reference and then through the test object, or in the reverse order. Different flows (i.e., flow velocities, mass flows, etc.) are approached at specific points and kept stable over a certain period of time. This procedure is called static adjustment/calibration. The synchronization between the test object and the reference is carried out via a synchronization signal. Adjusting and stabilizing the different flow velocities is time-consuming and prolongs the calibration and adjustment process

The object of the invention is to remedy this problem.

The object is achieved by the method according to claim 1 and by the flow meter according to claim 9.

The method according to the invention for adjusting and/or calibrating a flow meter, comprising the method steps of:
generating a flow profile in a line that is dynamic at least intermittently,
   wherein the flow profile exhibits a continuous increase in flow within a first time interval;
determining the flow profile by means of a reference flow meter during the first time interval,
   wherein a reference time value is assigned to a measured reference flow value,
   wherein the time value is determined by means of a reference clock, in particular the reference flow meter,
determining the flow profile by means of the flow meter during the first time interval,
   wherein a time value is assigned also to a measured flow value,
   wherein the time value is determined by means of a flow meter clock, in particular the flow meter;
adapting the flow profile determined by means of the flow meter, in particular iteratively, to the flow profile determined by means of the reference flow meter within the first time interval.

The advantage of the method according to the invention is that no precise controllers have to be used to set a desired flow. The adjustment and/or calibration times are significantly reduced because stabilization and adjustment of individual static flows is not necessary.

Furthermore, the number of adjustment and control points can be increased (increase in measured value density), and a more complete picture of the flow range is created. As a result of recording the two flow profiles, as well as the difference between the reference and the test object and also the adjustment carried out as a function of the two flow profiles, data is available for further offline evaluations. This means that, for example, suggestions for adjustments or flow profiles can be developed by means of machine learning methods. This requires a sufficient database, which is created in this way. This could potentially minimize an ‘overshoot’ of the target value.

During calibration, adapting the two flow profiles involves determining a deviation between the two determined flow profiles. According to DIN1319-1, calibration does not involve any intervention that would change the flow meter. Adapting the meter based on the results of the calibration is defined as an adjustment. During adjustment, adapting the two flow profiles results in a correction factor which must be applied to the determined flow profile of the flow meter so as to match the flow profile of the reference flow meter.

Flow meters are, in particular, Coriolis, ultrasound, vortex, thermal and/or magnetically-inductive flow meters. The reference flow meter may be different from the flow meter to be calibrated/adjusted.

Advantageous embodiments of the invention are the subject-matter of the dependent claims.

One embodiment provides for a temporal flow change in the first time interval to deviate from zero.

One embodiment provides for the reference clock and the meter clock to be synchronized in terms of time.

One embodiment provides for the reference clock and the meter clock to be subject to a precision time protocol, in particular to the precision time protocol according to IEEE1588 or 802.1AS.

The precision time protocol (PTP) is a network protocol that regulates synchronization of the time settings of multiple devices in a computer network in order to achieve high local accuracy. PTP is defined in IEEE 1588 and adopted in IEC 61588. According to the invention, the reference flow meter and the flow meter to be adjusted/calibrated are located in a network and each have communicating clocks. The clock with the most accurate time is the master clock. During operation, the master clock sends time signals to a slave clock in order to thus determine the delays between the master clock and slave clock. The master clock, i.e., the reference clock, does not necessarily have to be stored spatially in the reference flow meter. The reference flow meter can also have a slave clock that is in communication with the master clock.

One embodiment provides for the adaptation to be carried out by means of dynamic time warping.

Dynamic time warping is an algorithm used to determine similarities between two temporal sequences, i.e., in this case the two determined temporal flow profiles.

One embodiment provides for the flow profile to have a second time interval before the first time interval in which a flow pulse is impressed,
wherein a determination and/or adaptation of a time delay between the two determined flow profiles takes place in the second time interval.

Imprinting the flow pulse results in a clear and distinct characteristic in each of the two flow profiles, which can be assigned to a single common event. The flow pulse can, for example, be a step in the flow profile that results from the flow being increased for a short time and then kept constant. However, other shapes for the flow pulse are also conceivable, such as a temporary sawtooth profile. This can be achieved with a controllable pump or a controllable valve. The flow pulse can also be generated via a loudspeaker mounted externally on the pipeline in which the flow meter and the reference flow meter are also arranged.

One embodiment provides for the flow profile to have a third time interval after the first time interval in which the flow decreases continuously at least in portions,
wherein the third portion has at least one control point at which the flow determined by means of the flow meter is compared with the flow determined by means of the reference flow meter.

The advantage of this is that it can be checked whether, for example, sufficient adjustment has taken place. If the flow profiles deviate from each other when the flow decreases, the adjustment can either be continued, even when the flow decreases, or the flow is increased again and the adjustment continued.

Alternatively, the flow meter can subsequently be adjusted or calibrated again with the flow profile or with an alternative flow profile.

One embodiment comprises the method step of:
determining a dynamic calibration factor for the flow meter as a function of the two determined flow profiles.

The dynamic calibration factor is stored in the flow meter and can be used as a standalone factor or in combination with other calibration factors to determine the flow. In addition to the dynamic calibration factor, a static calibration factor can be provided, which is used when the flow to be monitored changes only slightly. The dynamic calibration factor, on the other hand, can be used whenever events occur in the flow that lead to (strong) flow fluctuations (e.g., opening of valves), i.e., large flow changes within a short time interval (a few seconds).

Alternatively, a deviation factor can be determined which provides information about the deviation of the flow meter to be calibrated.

For the flow meter according to the invention for determining a flow of a medium, an adjustment and/or calibration of the flow meter is carried out by means of the method according to the invention for adjustment and/or calibration.

One embodiment provides that at least one statically determined calibration factor is stored in the flow meter,
wherein at least one dynamically determined calibration factor is stored in the flow meter.

The advantage of this is that an accurate measured value can be ensured over a wide flow spectrum. A measuring circuit (comprising a microcontroller and electronic logic elements) stored in the flow meter can be configured to determine the flow either as a function of the dynamic calibration factor or as a function of the static calibration factor.

Instead of statically controlling different flows, a dynamic flow profile is used instead. The measured values of the references (reference flow meter) and test objects (flow meter) are recorded synchronously. A PTC (precision time protocol) can be used for this purpose. While the flow profile is being run, the deviation of the test object from the reference is calculated and automatically corrected (iteration method) until the determined measured values of the test object are within the desired tolerance. The determined flow profiles are mathematically superimposed. Latency times of the system can be determined dynamically, e.g., by applying a flow pulse at the beginning and determining the step response.

The invention is explained in greater detail with reference to the following figures, in which:

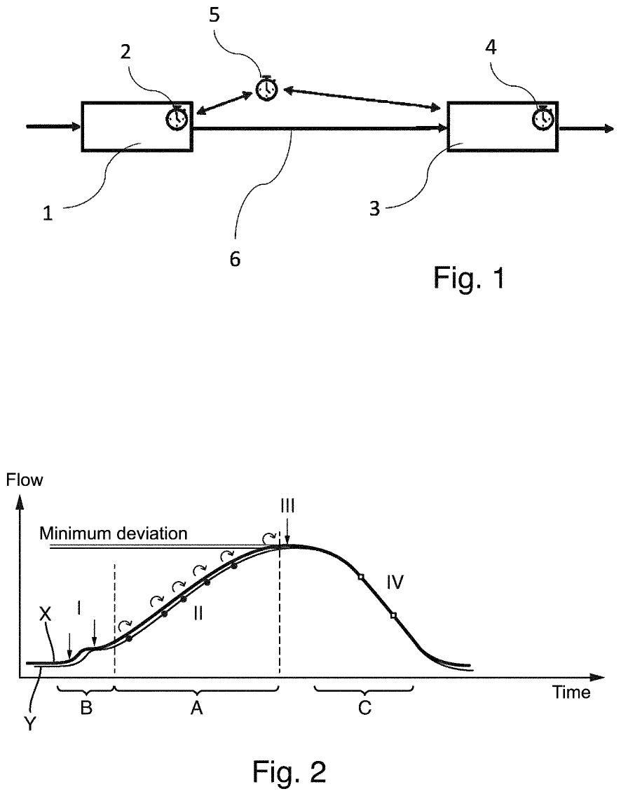

FIG. 1 shows a schematic representation of an adjustment/calibration system; and

FIG. 2 shows an embodiment of a flow profile (flow as a function of time).

FIG. 1 shows a schematic representation of an adjustment/calibration system. A flow meter 1 is arranged in front of a reference flow meter 3 in a pipeline, i.e., the medium first passes through the flow meter 1 and then through the reference flow meter 3. Alternatively, the reference flow meter 3 can be positioned upstream of the flow meter 1, opposite to the flow direction. It shall be appreciated that in addition to the flow meters 1, 3 shown, other components, such as a pump, a piston prover, a medium container, etc., are also part of the adjustment/calibration system. Furthermore, the adjustment/calibration system does not have to be a factory-installed system used only for adjusting and/or calibrating flow meters. Alternatively, the flow meter 1 is configured to carry out the method according to the invention for adjustment and/or calibration. It is further equipped with a flow meter clock 2 (slave clock). The currently determined flow measured values are provided with a time value which is determined by means of the flow meter clock 2. The reference flow meter 3 is also equipped with a flow meter clock 4 (slave clock). The flow measured values measured by means of the reference flow meter 3 are also provided with a time value which is determined via the flow meter clock 4. Both flow meter clocks 2, 4 are in communication with a reference clock 5 (master clock). The reference clock 5 is configured to synchronize the two flow meter clocks 2, 4 in terms of time. In this process, the precision time protocol according to IEEE1588 or 802.1AS is used. A calibration factor can then be derived from the determined flow profiles (flow as a function of time) of the flow meter and of the reference flow meter. This can be done iteratively when recording the flow profiles. An example thereof is shown in FIG. 2.

FIG. 2 shows an embodiment of the flow profile X (flow as a function of time) of a flow meter and the flow profile Y of a reference flow meter. The two flow profiles X, Y are divided into three time intervals A, B, C. The flow increases continuously in a first time interval A. Thus, the temporal flow change in time interval A is always greater than zero. During the first time interval A, the flow meter and the reference flow meter measure the flow. A time value is assigned to each flow measured value. This then results in the flow profile. There is a second time interval B before the first time interval A. In the second time interval B the flow jumps at least temporarily and then remains constant for a short period of time. This is a flow pulse (see I) in the form of a step. It is used to determine a latency or a time delay between the two flow profiles X, Y. After that, the flow increases continuously again. It can be seen that there are deviations in the absolute flow and in the temporal allocation of the determined flow measured values between flow profile X and flow profile Y. This becomes evident in particular by the flow pulse. According to the invention, this deviation is reduced during the measurement of the flow profile (see II) until the respectively determined flow measured values are recorded synchronously and there is only a tolerable minimal deviation between the respectively determined flow measured values (see III). The adaptation can be done iteratively and/or by means of dynamic time warping and provides a dynamic calibration factor for the flow meter. The flow is continuously reduced in a third time interval C. When reducing the flow, it is verified at individual control points (see two points in IV) whether the determined flow measured values substantially match.

1-10. (canceled)

11. A method for adjusting and/or calibrating a flow meter, comprising the method steps of:
generating a flow profile in a line that is dynamic at least intermittently,
wherein the flow profile exhibits a continuous increase in flow within a first time interval;
determining the flow profile by means of a reference flow meter during the first time interval,
wherein a reference time value is assigned to a measured reference flow value,
wherein the time value is determined by means of a reference clock, in particular the reference flow meter,
determining the flow profile by means of the flow meter during the first time interval,
wherein a time value is assigned also to a measured flow value,
wherein the time value is determined by means of a flow meter clock, in particular the flow meter;
adapting the flow profile determined by means of the flow meter, in particular iteratively, to the flow profile determined by means of the reference flow meter within the first time interval.

12. The method according to claim 11,
wherein a flow change in the first time interval deviates from zero.

13. The method according to claim 11,
wherein the reference clock and the flow meter clock are time synchronized in terms of time.

14. The method according to claim 13,
wherein the reference clock and the flow meter clock are subject to a precision time protocol, in particular to the precision time protocol according to IEEE1588 or 802.1AS.

15. The method according to claim 11,
wherein the adaptation is done by means of dynamic time warping.

16. The method according to claim 11,
wherein the flow profile has a second time interval before the first time interval in which a flow pulse is impressed,
wherein a determination and/or adaptation of a time delay between the two determined flow profiles takes place in the second time interval.

17. The method according to claim 11,
wherein the flow profile has a third time interval after the first time interval in which the flow decreases continuously at least in portions,
wherein the third time interval has at least one control point at which the flow determined by means of the flow meter is compared with the flow determined by means of the reference flow meter.

18. The method according to claim 11, comprising the method step of:
determining a dynamic calibration factor for the flow meter as a function of the two determined flow profiles.

19. A flow meter for determining a flow of a medium,
wherein an adjustment and/or calibration of the flow meter is carried out by means of a method for adjustment and/or calibration according to the following method:
generating a flow profile in a line that is dynamic at least intermittently,
wherein the flow profile exhibits a continuous increase in flow within a first time interval;
determining the flow profile by means of a reference flow meter during the first time interval,
wherein a reference time value is assigned to a measured reference flow value,
wherein the time value is determined by means of a reference clock, in particular the reference flow meter,
determining the flow profile by means of the flow meter during the first time interval,
wherein a time value is assigned also to a measured flow value,
wherein the time value is determined by means of a flow meter clock, in particular the flow meter;
adapting the flow profile determined by means of the flow meter, in particular iteratively, to the flow profile determined by means of the reference flow meter within the first time interval.

20. The flow meter according to claim 19,
wherein at least one statically determined calibration factor is stored in the flow meter,
wherein at least one dynamically determined calibration factor is stored in the flow meter.
